(19) United States
(12) Patent Application Publication
(10) Pub. No.: US 2011/0161325 A1
(43) Pub. Date: Jun. 30, 2011

(54) SYSTEM, METHOD AND COMPUTER-READABLE STORAGE MEDIUM FOR GENERATION AND REMOTE CONTENT MANAGEMENT OF COMPILED FILES

(75) Inventors: Anthony Jones, Brooklyn, NY (US); David Weil, New York, NY (US)

(73) Assignee: EGO7 LLC

(21) Appl. No.: 12/781,584

(22) Filed: May 17, 2010

Related U.S. Application Data
(60) Provisional application No. 61/291,633, filed on Dec. 31, 2009.

(51) Int. Cl. G06F 17/30; G06F 3/00

(52) U.S. Cl. 707/741; 715/733; 707/755; 707/756; 707/E17.005

(57) ABSTRACT

An apparatus is provided that includes a processor configured to perform or cause the apparatus to perform at least a number of operations. The operations include receiving a compiled media file including a plurality of objects, where the compiled file is received via a remoting gateway configured to post the compiled file to the apparatus. The operations also include parsing the compiled file to identify its objects and produce an index of the objects, and include mapping one or more data or files to one or more of the objects based on the index. The compiled file is servable to a viewer device, which includes receiving a request for the compiled file, and in response to the request, determining one or more data or files mapped to one or more of the objects, and serving the compiled file and the determined one or more data or files.

### CROSS-REFERENCE TO RELATED APPLICATIONS

The present application claims priority to U.S. Provisional Patent Application No. 61/291,633, entitled: System, Method and Computer-Readable Storage Medium for Generation and Remote Content Management of Compiled Files, filed on Dec. 31, 2009, the content of which is incorporated herein by reference.

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### FIELD

Example embodiments of the present invention generally relate to data management and, in particular, relate to mapping and dynamic management of data referenced to objects within compiled files over an electronic network.

### BACKGROUND

Advertisements, websites, landing pages and storefronts delivered over the Internet are typically created by an entity that desires to promote over an electronic network. It is common practice to utilize what is commonly known as rich media software such as Adobe Flash and Microsoft Silverlight in various ways to produce advertisements, websites, micro-sites and embedded rich media content to increase the level of engagement, influence and conversion of a viewer. The objective is to increase awareness of a brand or company, promote products and services and generate sales. The rich media asset can be a stand-alone entity or incorporated into designated areas of existing websites operated by a distinct party to be displayed to a viewer. Typically, the delivered assets are whole units, compiled files, and the entity creating and providing the rich media assets in various forms does not have the ability to easily alter the content of the files once compiled or to dynamically alter the objects of the compiled files or to obtain feedback based on the dynamically altered content mapped to the compiled files once provided to a server and requested by a viewer over a distributed electronic or digital network such as the Internet.

### SUMMARY

Although authoring environments enable compiled files to be quickly created, developed and maintained, problems remain with the external access to data and/or files from compiled web files. One problem is that when a web file is compiled and distributed it is common that the ability to access external data and/or files from compiled files is limited. In addition, the type of data and/or files pulled externally into the complied file is typically unknown. The operator may not have any indication as to the type of data and/or files that a particular object within the compiled file will accept. One way of dealing with this problem of accessing external data from objects within a compiled file is for the developer to manually program/hardcode references to the external repository to access the data and/or files from the determined location.

With a slightly more elaborate approach, a developer may manually create references to the objects in an external database so that the external data and/or files to be related to the object within the compiled file can be retrieved. Regardless of how this is implemented, the external data and the objects within the compiled files may be tightly coupled and in many cases, to a higher degree, the data source and the object may be completely dependent on each other. A better approach is sought for loosely coupling and mapping external data and/or files to objects within a compiled file. Example embodiments of the present invention may fulfill this and other needs.

In view of the foregoing, example embodiments of the present invention provide an apparatus, method and computer-readable storage medium. According to one aspect of example embodiments of the present invention, an apparatus is provided that includes a processor configured to perform or cause the apparatus to perform at least a number of operations. The operations include receiving a compiled media file including a plurality of objects each of which has a particular type. In this regard, the compiled file is received via a remoting gateway configured to post the compiled file to the apparatus.

The operations also include parsing the compiled file to identify the objects of the compiled file and produce an index of the objects. In addition, the operations include mapping one or more data or files to one or more of the objects based on the index of the objects, where each data or file is of a type conforming to the type of the object to which the respective data or file is mapped. The compiled file is servable to a viewer device, which includes receiving a request for the compiled file, and in response to the request, determining one or more data or files mapped to one or more of the objects of the compiled file, and serving the compiled file and the determined one or more data or files.

The operations that the processor is configured to perform or cause the apparatus to perform may further include receiving a request for the compiled file. In response to the request, the operations may include determining one or more data or files mapped to one or more of the objects of the compiled file, where the respective one or more data or files are determined based on the mapping. And in response to the request, the operations also include serving the compiled file and the determined one or more data or files, where the compiled file and objects of the compiled file are thereby presentable with the respective one or more data or files.

The mapping of one or more data or files may include exposing references to identities of the compiled file and the objects of the compiled file, where the references are exposed to a graphical user interface at least partially based on the index of the objects. In addition, the mapping may include receiving input directing the mapping of one or more data or files to one or more of the objects, where the input is similarly received via the graphical user interface and based on the references. In such instances, the graphical user interface may be implemented by a remote device configured to access the references and provide the input via a network. Similarly, and more generally, the one or more data or files mapped to the objects of the compiled file may be stored remote from the compiled file, and may be accessible to the apparatus via a network.

The mapping of one or more data or files may include mapping a plurality of data or files to each of one or more of the objects. For each object mapped to a plurality of data or files, then, determining one or more data files may include determining one of the respective data or files based on one or more logic rules. For example, a plurality of textual data mapped to an object of the compiled file may be three exclusive objects of data that may contain “10% off,” “20% off” and “30% off.” A logic rule may trigger the selection of one of the data objects in a sequential manner upon a request for the compiled file.

The aforementioned receiving a compiled file, parsing the compiled file, and mapping one or more data or files to one or more of the objects may occur for a plurality of different compiled files. In such instances, the processor may be configured to further perform or cause the apparatus to further perform receiving a request for a compiled file. And in response to the request, the processor may be configured to perform or cause the apparatus to perform determining one of the compiled files to serve, determining (based on the mapping) one or more data or files mapped to one or more of the objects of the determined compiled file, and serving the determined compiled file and one or more data or files. Similar to before, the determined compiled file and objects of the compiled file may thereby be presentable with the respective one or more data or files.

In instances of serving the compiled file, the request may be received from a viewer device, and the determined compiled file and one or more data or files may be served to the viewer device. Also in such instances, the processor may be configured to further perform or cause the apparatus to further perform receiving feedback from the viewer device before determining one of the compiled files to serve. One of the compiled files to serve may then be determined based on the feedback.

As indicated above and explained below, example embodiments of the present invention may solve problems identified by prior techniques and provide additional advantages.

### BRIEF DESCRIPTION OF THE DRAWINGS

Example embodiments of the present invention will be understood and appreciated more fully from the following detailed description taken in conjunction with the drawings in which:

FIG. 1 is an illustration of a system in accordance with example embodiments of the present invention;

FIG. 2 is a block diagram of a development environment in which example embodiments of the present invention may be embodied;

FIG. 3 is a flowchart illustrating various steps in a method of generating and systematically parsing compiled files at runtime, in accordance with example embodiments of the present invention;

FIG. 4 is a flowchart illustrating various steps in a method of updating parsed objects with data and/or files at runtime, in accordance with example embodiments of the present invention; and

FIG. 5 is a flowchart illustrating various steps in a method of generating, parsing and serving a compiled file to a viewer subject to rules-based selection and viewer feedback, in accordance with example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. Reference may be made herein to terms specific to a particular system, architecture or the like, but it should be understood that example embodiments of the present invention may be equally applicable to other similar systems, architectures or the like. More particularly, example embodiments of the present invention may be described with respect to developing, deploying and using compiled files, which may be applicable in a number of different contexts. For purposes of illustration, the compiled file may be an advertisement as used herein an “advertising unit” or “ad unit.” Examples of advertising units may include, but are not limited to, banner advertisements, floating advertisements, expanding advertisements, videos or the like.

The terms “data,” “content,” “information” and similar terms may be used interchangeably, according to some example embodiments of the present invention, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

The term “Flash” may relate to any version of Adobe Flash, versions 8, 9 and higher versions, or any other Flash-type product utilizing Flash or a similar scripting or other programming language. Suitable examples of Flash are provided by Macromedia or Adobe Systems.

The term “content management” may relate to creation of the relationship and the updating of data and/or files related to objects of a compiled file. The term “generation” may relate to the compiling of a program, file or the like. And the term “component” may relate to a component library, component module, component engine, object or the like.

Example embodiments of the invention relate to an apparatus, method and computer-readable storage medium for the creation and remote content management of compiled files. Example embodiments of the present invention may allow for dynamic creation and control. Example embodiments may also create tracking capabilities as to the destination of and interaction with compiled files and rules based selection of content related to the compiled files.

Example embodiments of the present invention are generally directed to an apparatus, method and computer-readable storage medium to dynamically enumerate and/or update data and/or files mapped from external sources to objects within a compiled file. Example embodiments of the present invention may be used to create and manage compiled files in the context of rich media assets such as advertisements, websites, landing pages, storefronts and web-applications and derivatives of these that are compiled and may be hosted on a server.

In one example embodiment, data and/or files located at a second processor-based device (e.g., a data source such as a server) may be mapped to one or more objects within a compiled file hosted on a first processor-based device (e.g., the same or another server). The compiled file, its respective objects and the data and/or files mapped to those objects may then be transmitted to a viewer over a distributed electronic network, such as a wide area network (WAN) like the Internet. Example embodiments of the present invention may parse a compiled file at runtime in order to dynamically identify and index objects within the compiled file, and store references to the compiled file and objects within a repository to which data and/or files may then be mapped from remote or external data sources. The compiled file may be a whole unit.

Mapping or otherwise relating external data and/or files to objects within a compiled file may result in a loose coupling of the compiled file and its objects to the data and/or files such that the respective data and/or files may be simultaneously available and mapped to multiple and unrelated instances of the objects within the compiled file. Upon receiving a compiled file from a developer or user to a server, the compiled file may be stored and parsed at runtime—to identify the compiled file and its objects rendering a structured output that may be read and stored in a repository such as a database.

The references and parameters of the objects of the compiled file may be exposed externally to the owner and/or designated agent or other controlling system via a graphic user interface or exposure to third party data sources. The stored references to the dynamic objects may be categorized and rendered according to compatible data types per object within the compiled files allowing a developer, non-technical user, or program to systematically map and link conforming data and/or files from remote data sources to the identified dynamic objects of the compiled file at runtime thereby eliminating the need for an application programming interface or authoring environment.

The externalization of data and/or files significantly reduces the KB size of the compiled file. Data and/or files mapped to the compiled file may be served based on client request thereby distributing the size of the load and measurably decreasing load times.

In one example embodiment, a method, system and computer program at a first server may store the compiled file. The objects of the compiled file are parsed, identified and referenced at a second server. The identifications represent data types of the objects within the compiled file to which values can be externally mapped through a user interface or mapped programmatically to the objects of the compiled file and served in real-time upon client request.

A processor based device (e.g., server) stores a compiled file, receives from client a request for a compiled file, based on the request, select at the server the destination of the compiled file, and transmit the compiled file to the client, the rich media asset. On a viewer indication, the viewer may interact with the rich media asset, compiled file, or be redirected to another web location such as a web page, landing page or microsite. The client may be the computer of a viewer. The data and/or files residing on a second server and mapped to the objects of the compiled file requested by the client can be monitored and managed by the owner or designated agent of the compiled file. The reference to the compiled file may or may not be requested through a conduit such as an advertising server or other intermediary. The management may be determined according to a set of rules, analytical information, assumption or based on a combination of criteria and performed programmatically, subjectively or randomly and transmitted in real-time.

The combination of evaluative criteria may reveal statistical relevant data where an optimal combination of content (data and/or files) occurred and the managed content (data and/or files) mapped to the compiled file may be the preferred combination to be served to the viewer.

In another example embodiment a method, system and computer program to manage the data of a set of related or unrelated compiled files presented to a remote viewer as a whole unit. The series of compiled files may be referenced as a single unit, a rich media asset in a distributed manner. The series of compiled files can be represented as a website, landing page, microsite, display advertisement or other promotional messaging. The incremental loading of a series of compiled files and their respective objects, and the data and/or files mapped to those objects reduces the KB size of the compiled unit distributing the size of the load and measurably decreasing load times, wherein the set of compiled files are requested by a client and produce a display for a viewer.

In another example embodiment a method, system and computer program to enumerate data and/or files related to objects of the compiled file which are external to the compiled file, or set of compiled files. The mapping by similar data type of data and/or files to the objects of the compiled file or set of compiled files on the first server can represent a one-to-many relationship wherein the data and/or files on the second server are mapped to the objects of the compiled file or set of compiled files and can be varied. Upon client request the combination of data and/or files can result in a version of the enumerated data and/or files that are mapped to the objects of the compiled file.

In another example embodiment of the present invention evaluate or reference external data and optimize the combination of enumerated data and/or files linked to the objects within the compiled file or set of compiled files and presented to the viewer in real-time. The enumerated data mappings can be dynamically selected according to a set of rules, analytical information, an assumption or based on a combination of criteria and performed programmatically, subjectively or randomly and transmitted in real-time.

In another example embodiment of the present invention may evaluate or reference external data and may target the destination of a compiled file or set of compiled files and based on a request transmit the compiled file or set of compiled files to a viewer. On a viewer indication, the viewer may interact with one of the compiled files and based on viewer interaction be led to interact with a variable set of compiled files and/or combinations of enumerated data and/or files linked to the objects within the compiled file or set of compiled files requested by a client and presented to the viewer in real-time.

In another example embodiment of the present invention may include tracking the quantity, frequency, placement, location and other measurable aspects of the compiled files or set of compiled files and the data and/or files mapped to the objects of the compiled file or set of compiled files. Furthermore, viewer interaction with the compiled file or set of compiled files can be tracked.

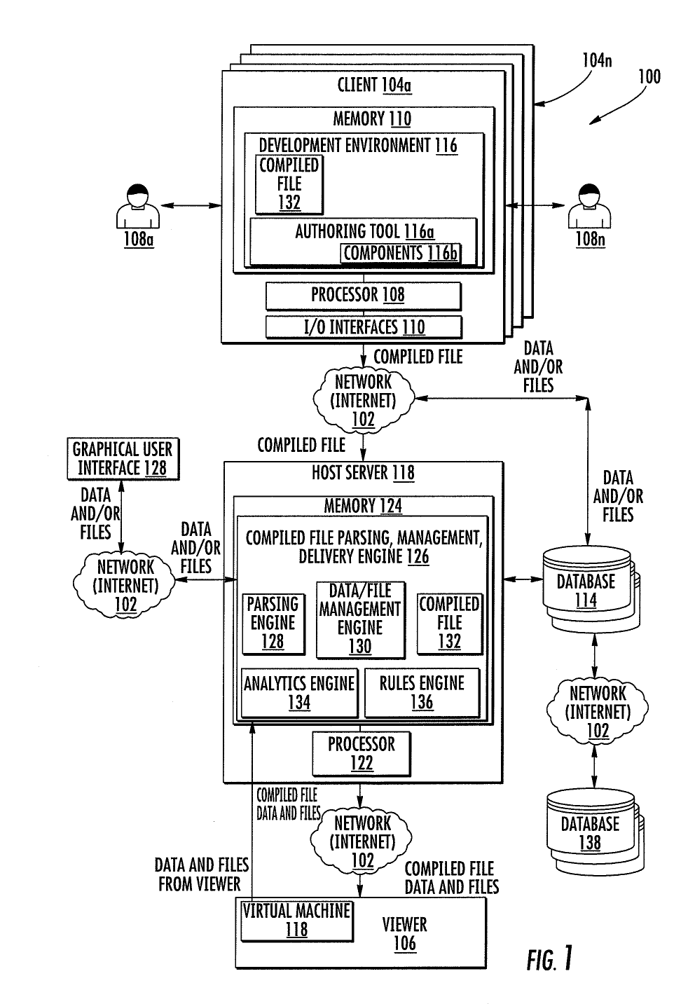

Reference is now made to FIG. 1, which illustrates a system 100 for the creation and remote content management of compiled files according to example embodiments of the present invention, where the system may be implemented in a networked environment. The configuration and arrangement of the elements shown and described with respect to FIG. 1 are shown by way of example only, and other configurations and arrangements of system elements can exist in accordance with other example embodiments of the invention. Those skilled in the art will also find that the example embodiments of the present invention may be embodied on any of a number of different platforms, including for example Macintosh, Linux, UNIX or the like.

As shown, the system 100 may include a communications network 102 in communication with at least one back-end client device 104 (a number of client devices being shown as client devices 104a-104n), and at least one front-end viewer device 106. In this example embodiment, the client devices 104 and viewer devices can be associated with respective users 108 (a number of users being shown as users 108a-108n). The communications network 102 shown in FIG. 1 may be any communications network capable of transmitting signals, including image data signals or multimedia signals. Such communications networks may include one or more of any of a number of different wired or wireless personal area networks (PANs), local area networks (LANs), campus area networks (CANs), metropolitan area networks (MANs), wide area networks (WANs), global area networks (GANs), virtual private networks (VPNs), or the like. The network 102 may implement any number of communication protocols including, for example, TCP/IP (Transmission Control Protocols/Internet Protocol). The network 102 may also implement any number of protocol overlay technologies including MPLS (Multi-Protocol Label Switching).

Each client device 104 and viewer device 106 can be a computer or processor-based device capable of communicating with the communications network 102 via a signal, such as a wireless frequency signal or a wired communication signal. Examples of client devices 104 or viewer device 106 are personal computers, mobile computers, handheld portable computers, digital assistants, personal digital assistants, cellular phones, mobile phones, smart phones, pagers, digital tablets, desktop computers, laptop computers, Internet appliances and other processor-based devices. In general, a client device 104 or a viewer device 106 may be any type of processor-based platform that is connected or connectable to a network 102, and that interacts with one or more application programs including computer-executable program instructions. The client devices 104 or viewer device 106 may operate on any operating system capable of supporting a browser or browser-enabled application, such as Microsoft® Windows® or Linux. The client devices 104 or viewer device 106 shown include, for example, personal computers executing a browser application program such as Microsoft Corporation's Internet Explorer™, Netscape Communication Corporation's Netscape Navigator™, Mozilla Firefox™, and Apple Computer, Inc.'s Safari™.

Each client device 104 and viewer device 106 may include a number of similar components, a number of which are described below and shown in FIG. 1 with respect to the client device. In this regard, each client device 104 and viewer device 106 may include a processor 108 and an input/output (I/O) interface 110 configured to interface the client device 104 with the network 102.

The processor 108 may include any of a number of suitable processors such as a microprocessor, an ASIC, and state machines. Such processors also include, or may be in communication with computer-readable storage media such as a memory 112 that stores computer-executable program instructions which, when executed by the processor, cause the respective client device 104 or viewer device 106 to perform various operations described herein. The memory 112 may include memory embodied within a client device 104 or viewer device 106 and/or memory accessible across the network 102 such as in the form of a network-accessible storage device, database 114 or the like.

The memory 112 may include volatile and/or non-volatile memory configured to more generally store data, content, information or the like. Example computer-readable storage media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor may read instructions. The instructions may comprise code from any computer-programming language, including, for example, C, C++, C#, Visual Basic, Java, Python, Perl, PHP, ActionScript, JavaScript or the like.

The computer-executable program instructions stored in the memory 112 may include a number of different software data, information, software or the like. In the case of a client device 104, for example, the software stored in the memory 112 may include a development environment 116; and in the case of a viewer device 106, for example, the software may include a virtual machine 118. The development environment may include an authoring tool 116a with one or more component modules, engines or the like 116b (generally referred to herein as component modules 116b), which component module may include one or more components. Examples of an authoring tool 116a may include a Flash or Silverlight authoring tool, such as Adobe Flash 9 or Microsoft Silverlight. One example of a component module is the Wildfire component module which is distributed by EGO7 LLC of New York City, N.Y. The component module 116b may be configured to implement a method for the generation and remote content management of compiled files such as a rich media advertising unit, in accordance with example embodiments of the present invention. Other examples of functionality and aspects of the example embodiments of a component module 116b are described below.

Each client device 104 or viewer device 106 may also include or otherwise be in communication with an output device configured to display information. Suitable types of displays include, but are not limited to, private-type displays, public-type displays, plasma displays, LCD displays, touch screen devices, projector displays on cinema-type screens or the like. Further, each client device 104 or viewer device 106 may include or otherwise be in communication with one or more user input devices such as a mouse, a CD-ROM player or recorder, DVD player or recorder, a keyboard or the like.

As also shown in FIG. 1, the system 100 may also include a server 120 in communication with the network 102, and consequently the client devices 104 and/or viewer device 106 via the network 102. In one example embodiment, the server 120 may be in communication with a network. The server 120 is depicted as a single computer system, but may be implemented as a network of computer processors. Examples of suitable server 120 are servers, mainframe computers, networked computers, a processor-based device, and similar types of systems and devices.

Similar to the client devices 104 and viewer device 106, the server 120 may include a processor 122 coupled to a memory 124. The processor and memory may be any of a number of different suitable processors and memory, such as any of those described above with respect to the client device processor 108 and memory 112.

Similar to the client device memory 112, the server memory 124 may include memory embodied within the server 120 and/or memory accessible across the network 102 such as in the form of a network-accessible storage device, database 114 or the like.

The memory 124 may be configured to store software including, for example, a compiled file parsing, management and delivery engine 126 that may be accessed by a suitable graphical user interface 128. The graphical user interface 128 may be implemented by the server 120, or as shown in FIG. 1, the graphical user interface may be implemented by a separate device (including, e.g., a suitable processor and memory) accessible across the network 102.

The compiled file parsing, management and delivery engine 126 may include one or more of a parsing engine 128, data/file management module 130, compiled file 132, analytics engine 134 or rules engine 136. One example of a compiled file parsing, management and delivery engine 126 is the Wildfire™ Platform which is distributed by EGO7, LLC of New York, N.Y. The compiled file parsing, management and delivery engine 126 may be configured to implement a method for the generation and remote content management of compiled files, such as a rich media advertising unit. In addition, compiled file parsing, management and delivery engine 126 may be configured to receive one or more signals from one or more client devices 104 or viewer devices 106. Other examples of functionality and aspects of the example embodiments of compiled file parsing, management and delivery engine 126 are described above with respect to the development environment 116.

The memory 124 and database 114 can be in communication with any number of other databases 138, such as a centralized database, or other types of data-storage devices. When needed, data stored in the memory 124 or database 114 may be transmitted to a centralized database configured to receive data, information, or data records from more than one database or other data storage devices.

The server 120 may be configured to transmit and receive information to and from multiple sources via the network 102, including the client devices 104, viewer device 106, and/or the database 114 or other data storage device. Client device such as 134 may have virtual machine 136 to view compiled files. Virtual machine 136 may allow the viewer to transmit and receive from server 114 information which may be sent to analytics engine 128, rules engine 130 and data/file management module 124 of compiled file parsing, management and delivery engine 126.

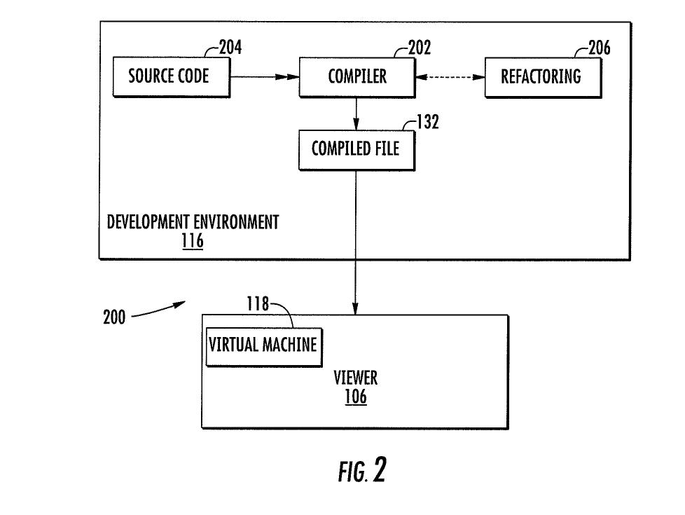

Reference is now made to FIG. 2, which illustrates a block diagram 200 of aspects of the development environment 116 in which example embodiments of the present invention may be implemented. As indicated above, the component module 116b may facilitate the generation of remotely manageable compiled files. In one example embodiment, the component module 116b may plug into or otherwise operate in conjunction with a suitable authoring tool 116a to facilitate the generation of remotely-manageable compiled files. The component module 116b may be packaged as a single extensions file, e.g., “Wildfire.mxp,” that may be installed on an associated client device 104. To facilitate execution of the file, the authoring tool 116a may be simultaneously executed on the client device 104. When both the component module 116b and authoring tool 116a are executed, the component module 116b may be suitably configured to operate with the authoring tool 116a to provide additional functionality. For instance, the component module 116b may provide one or more tools or creative application program tools for use by one or more users within the development environment 116.

As shown in FIG. 2, then, the development environment 116 may include an authoring tool 116a that, operable with a component module 116b, includes a compiler 202 configured to generate a source code 204 for a program, file or the like, and generate a compiled file 132 from the source code such that the compiled file may be remotely managed. The source code may be compiled into any of a number of different formats, but in one example embodiment, the source code may be compiled into a compiled file formatted in accordance with the Adobe small web format (*.swf). In various instances, the authoring tool 116a may include a refactoring module 206 configured to refactor the source code to thereby improve the quality attributes of the software. The compiled file may then be retrieved by the virtual machine 118 of a viewer device 106, which may decompile the complied file to access and render the source code within the compiled file in a viewable format.

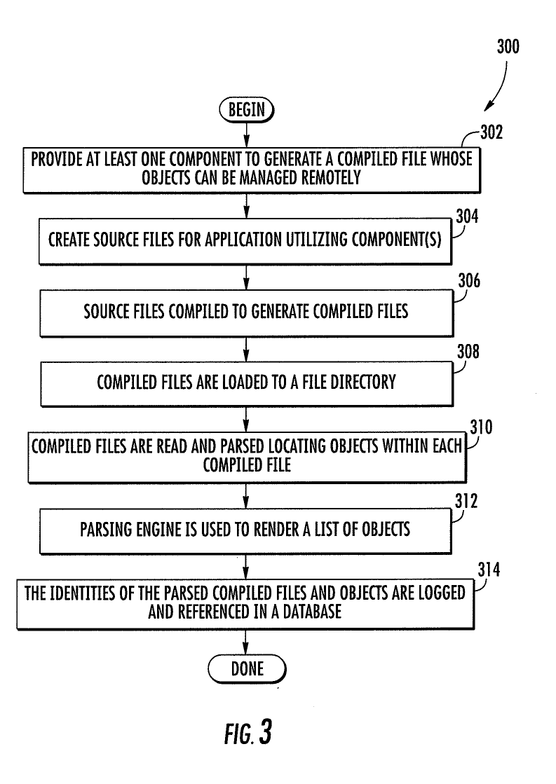

FIG. 3 is a flowchart illustrating various steps in a method 300 of generating and systematically parsing compiled files at runtime, in accordance with example embodiments of the present invention. As shown in block 302, the method may include a component module 116b providing at least one component for generating a compiled file 132 whose objects are remotely manageable. The components provided by the component module 116b may be organized in a component library. In one instance, a hard-coded source code file may be created from a static platform that includes unalterable binary components and parses pre-built components. In another instance, a lightweight object-based framework and class library may be provided. An open platform may include an object-oriented architecture with developer APIs (application programming interfaces) to distribute the capability to third-party creators of components.

Objects of the compiled file may be generated from the components provided by component module 116b. In this regard, the components used when authoring the compiled file may become objects upon generation of the compiled file. Components may include a text area, image area, video area, list area, button, form and the like. These component types may be classified as an object type to which a conforming type of data and/or files or applications may be mapped to the object. For example, a component may be a text area, and when the compiled file is generated it may be classified as a text area object of the compiled file.

Other components that may be provided include, for example, drag and drop-type functionality, an event, a command, a template, a testing component, a control button, a method, code hint or the like. For example, the component module 116b may be configured to add drag and drop-type functionality to a components panel in a suitable authoring tool 116a, such as a Flash or Silverlight authoring tool, that includes a stage for developing a file (e.g., advertisement). A user 108 of the respective client device 104 may then drag and/or drop one or more components to the stage of the authoring tool 112a to generate templates, buttons, text, image, and navigation, a video gallery, image gallery, chat, blog, bulletin board, calendar, form or the like. In another example embodiment, the drag and drop-type functionality may include components such as slider, toggle, click-through, panel, pause, play, progress bar, replay or the like.

Event-type functionality may include, for example, setting a time-based video event, setting a user action-based event such as when a user rolls over a button, setting an event such as when a predetermined image is revealed or the like. Command-type functionality may include, for example, a standard task, adding video, and any command function which can be performed after a compiled file has generated. Examples of template-type functionality include a predetermined size for a template, a predetermined format for a template, a microsite template, and a landing page template, a banner template or the like. And testing component-type functionality may include, for example, testing a template.

In yet another example, the component module 116b may add methods and code hints functionality or tools into the authoring environment of the authoring tool 116a. Code hints and methods are standard features in the context of object oriented programming languages such as Adobe Flash. In the context of the Wildfire component module a user 108 may type “wildfire” within the authoring environment to prompt any number of object-oriented programming methods, techniques or the like. Other methods may be loaded within respective component sets within the authoring environment, and may be called by the user 108 using an appropriate command.

Regardless of the exact components provided by the component module 116b, the components may be utilized in the authoring tool 116a to create one or more source code files 204, as shown in block 304.

As shown in block 306, after the source code file 204 is created, the source code file 204 may be compiled to generate one or more compiled files 132. In one example embodiment, the authoring tool 116a may be configured to generate a compiled file 132 which may include components whose objects are remotely manageable. The source code file may be compiled to generate one component file, or multiple compiled files or a series or set of related compiled files that may include components whose objects are remotely manageable.

As shown in block 308, the compiled file 132 may be loaded into a file directory. The file directory may be resident in the memory 112 of the respective client device 104. Alternatively, in one example embodiment, the file directory may be resident in the memory 124 of the server 120, or may be resident in network-accessible memory, database 114, 138 or the like. In these example embodiments, the compiled file 132 may be loaded into a file directory of the respective memory 114, 124, 138 via a communication network 102.

As or after the compiled file 132 is loaded into the file directory, the compiled file 132 may be read and parsed to locate each object within the compiled file 132, as shown in block 310. In one example embodiment, the compiled file 132 may be parsed by a parsing engine 128, which may be configured to systematically read the binary code of the compiled file 132, and locate and identify the objects contained within the compiled file 310. In one instance, the parsing engine 128 may be configured to parse text and image files and use the HTTP post method to post data. In another instance, the parsing engine 128 may be configured to parse any object (e.g., storefront, list application, calendar application, music player application), may parse all programming language versions (e.g., Actionscript 1.0, 2.0, 3.0) and may utilize a remoting gateway to post data.

After reading and parsing the compiled file 132 to locate each object within the compiled file 132, the parsing engine 128 may render a list of objects, as shown in block 312. In this regard, the parsing engine 128 may systematically render the list in a data structure that categorizes the compiled file and its objects in a format that that may be logged and/or stored in a database, such as database 114. In one more particular example, the list may be rendered in an extensible markup language (XML) document and stored in a database. Thereafter, the identity of the parsed compiled file 132 and the compiled file's objects may be logged and referenced in a database, such as database 114, as shown in block 314.

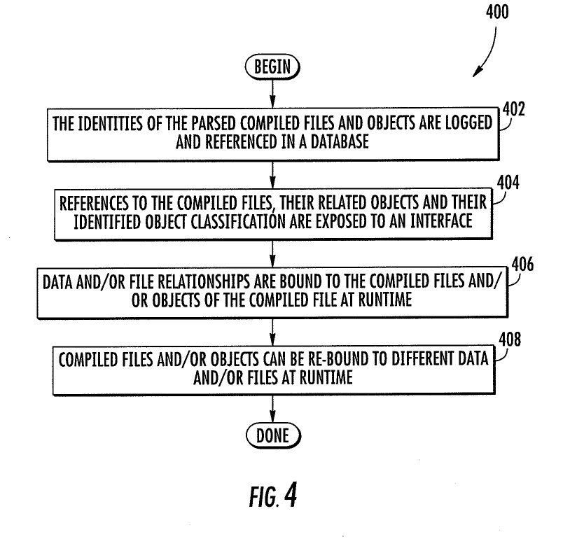

FIG. 4 is a flowchart illustrating various steps in a method 400 of updating parsed objects with data and/or files at runtime, in accordance with example embodiments of the present invention. As shown in block 402, the method may include logging the identity of a parsed compiled file 132 and the compiled file's objects, and referencing the identity of the parsed compiled file 132 and the compiled file's objects in a database, such as database 114.

As shown in block 404, the method may also include exposing, to a graphical user interface, the references to the identity of the parsed compiled file 132 and the compiled file's objects, as well as the classifications of the respective objects.

| contentLinkageID | pageID | contentAreaID | contentType | resourceID | textID | listID | galleryID |
|---|---|---|---|---|---|---|---|
| 3044 | 372 | 2027 | text | 0 | 565 | 0 | 0 |
| 3045 | 372 | 2028 | text | 0 | 548 | 0 | 0 |
| 3046 | 372 | 2029 | text | 0 | 549 | 0 | 0 |

For example, the compiled file may be given a pageID reference, such as pageID 372. The compile file may also contain objects and those objects may be content area objects such as contentAreaID 2027 and that content area may have a contentType such as contentType ‘text’ and may be classified as such. Upon the contribution of data and/or files to a server 120, in this case the data type is text, the text may be given an ID such as textID 565. The classified data then may be mapped via a graphical user interface or programmatically to the object, in this case a text object. Upon viewer request, the compiled file may be served and at runtime the objects may request the mappings to the data and/or files and the content may be served to the viewer.

In one example embodiment, graphical user interface 128 in communication with the network 102 in FIG. 1 may be utilized to access the references stored in a database 114, such as via the data/file management engine 130 of compiled file parsing, management, delivery engine 126. As shown in block 406, the method may include binding the compiled file 132 and/or its objects to data and/or files at runtime of the compiled file. In this regard, a graphical user interface 128 in communication with the network 102 may be employed by a respective user to direct the mapping of data and/or files to the objects of the compiled file at runtime of the compiled file, thereby binding the objects to the respective data and/or files.

In another example embodiment, references to the compiled file, its objects and their classifications may be exposed via a database, such as database 114, which communicates with another database, such as database 138, in which a compiled file and/or its objects may be bound to data and/or files at runtime. A database 114 in communication with the network 102 may communicate with another database 138 to receive data and/or files from the other database 138 so that the data and/or files mapped to the objects of a compiled file at runtime may be bound. The mapping of data and/or files to the objects of a compiled file whether directed by a graphical user interface or programmatically a one-to-one relationship may exist between a compiled file's object and data and/or files via a single reference to the respective data and/or files. In another instance, multiple data and/or file relationships may be bound to the compiled files object or objects. In either instance, references to data and/or files may be bound to a compiled file's object or objects with or without a security layer to protect the data and/or files. If a security layer is implemented it may be such that the data and/or files may be remotely retrieved via a security protocol.

As shown in block 408, a compiled file and/or its objects may be re-bound to different data and/or files at runtime. In one example embodiment, the graphical user interface 128 in communication with the network 102 may be employed by a respective user to direct the re-binding of data and/or files to the objects of a compiled file at runtime of the compiled file. In another example embodiment, the mapping of data and/or files to the objects of a compiled file at runtime may be automatically re-bound without the need of a graphical user interface, such as in the context of a database 114 communicating with another database 138 via a communication network 102.

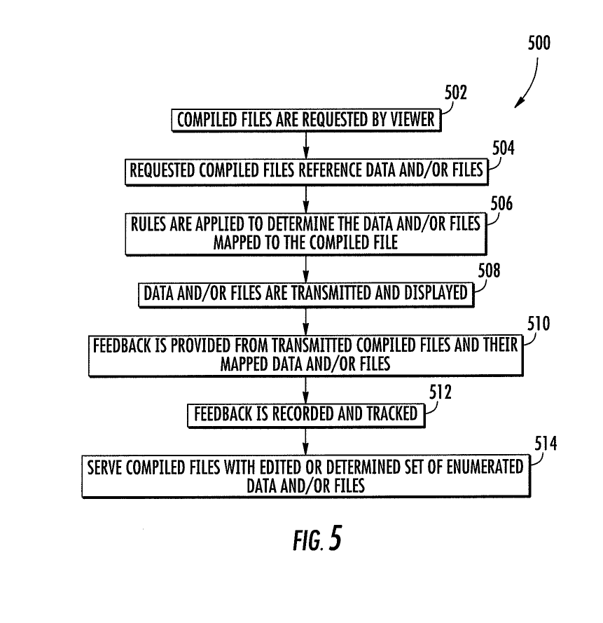

FIG. 5 is a flowchart illustrating various steps in a method of generating, parsing and serving a compiled file to a viewer subject to rules-based selection and viewer feedback, in accordance with example embodiments of the present invention. As shown at block 502, the method may include a viewer device 106 requesting a compiled file 132 whose objects are remotely manageable. For example, a viewer device 106 may request a website via network 102. The viewer device 106 may navigate to a web page including an area that may be read by the device's virtual machine 118, where the area of the web page references the location of a compiled file 132 residing on a server 120. In one example embodiment, the area of the web page may be a display advertising area. In this regard, configurations of designated display advertising areas may be defined by the Internet Advertising Bureau or another organization that may be deemed an authority within the online display advertising industry.

After the viewer device requests the compiled file 132, a rules engine 136 may apply one or more rules to determine any data and/or files mapped to the compiled file, as shown in block 504. The respective data and/or files may be transmitted and displayed by the viewer device 106, as shown in block 508. For example, the virtual machine 118 of the viewer device 106 may access or otherwise receive, from the server 120 or other memory (e.g., database 114, 138), the compiled file 132 and its mapped data and/or files provided by a data/file management engine 130 configured to serve the compiled file with the determined combination of data and/or files as per the applied rules. The viewer device 106 may then display the compiled file and its mapped data and/or files.

As or after the data and/or files are displayed, the viewer device 106, or more particularly for example the virtual machine 118 of the viewer device 106, may provide feedback to the server 120, or more particularly the analytics engine 134 of the server, which may record and track the feedback, as shown in blocks 510 and 512. In another example embodiment, feedback may additionally or alternatively be provided by a third-party server or apparatus that may be configured to operate as a proxy for transmitting the compiled file 132 and its mapped data and/or files to the viewer device 106. For example, the Doubleclick Dart for Advertisers platform may provide a reference to the compiled file, and in doing so, the respective platform may provide a capability that allows for the gathering of data that may be transmitted to the analytics engine 134.

Tracking objects, click-through objects or the like may be used to gather feedback. Examples of these objects may be links embedded in an advertising unit, links associated with a video or other content, and links associated with the location of a compiled file.

The analytics engine 134 may record and track any of a number of different feedback regarding the compiled file 132 and/or its mapped data and/or files. For example, the analytics engine 134 may record and track the location, time and size, and/or dimension of the compiled file. Additionally or alternatively, for example, the analytics engine 134 may record and track the combination of objects contained within the compiled file 132, and/or the combination of data and/or files mapped to the compiled file. As another example, the analytics engine 134 may record and track events representative of a viewer device's interaction with a compiled file 132. In this regard, trackable events may include, for example, a clickthrough, a selection of a navigation item, launching of a video, a rollover, entering data into a form field or the like.

As shown in block 514, the method may also include the server 120 serving a viewer device 106 with a compiled file 132, data and/or files, any of which may be edited or otherwise dynamically determined as a function of feedback recorded and tracked by the analytics engine 134. In one example embodiment, the rules engine 136 may determine which compiled file 132 to serve to a viewer device 106 as a function of feedback data provided by the analytics engine 134. In this regard, the rules engine 136 may be configured to implement a matching function to represent an outcome. For example, the systems and methods of example embodiments of the present invention may be used to create various identifiers and associate those identifiers to compiled files or data and/or files that are mapped to the objects of the compiled files and then configure the rules engine to identify a match to the feedback which is provided by an analytics engine. An illustrative example embodiment may use one or more of the following inputs:

(a) User to whom the compiled file may be displayed. The user may be identified using a browser cookie, among other means.

(b) Web page on which the compiled file may be displayed. The web page may be identified using a URL.

(c) Time-of-day when the compiled file may be displayed.

(d) Templates that contain the visual creatives and verbal messaging that are mapped to the objects of the compiled file.

Each input as illustrated above may have several features associated with it. A feature of the input may be a name, value pair. Such as for example, a particular user may have geo-location=New York, time=3 PM as features and may have the features category=Car Model, price=$21,500.00, brand=BMW, associated with it. In this example embodiment, inputs that are contained in the request select a compiled file and a determined combination of enumerated data and/or files to be mapped to the compiled file. For example, the analytics engine 134 may provide feedback data that supplies a web page address, and in response, the rules engine 136 may provide a match for that feedback data thereby invoking the data/file management engine 130 to determine and serve a compiled file 132 and mapped data and/or files based on a match.

In another example embodiment, the rules engine 136 may implement one or more rules each of which includes a mathematical function termed as an objective function to represent an outcome. One example of such a rule is the ratio of viewers requesting versus requesting and interacting with a compiled file 132.

According to one aspect of the example embodiments of present invention, the functions performed by the various network elements (e.g., client device 104, viewer device 106, host 120, etc.), such as those illustrated by the flowcharts of FIGS. 3, 4 and 5, may be performed by various means. It will be understood that each block or operation of the flowcharts, and/or combinations of blocks or operations in the flowcharts, can be implemented by various means. Means for implementing the blocks or operations of the flowcharts, combinations of the blocks or operations in the flowcharts, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions may be stored on a memory device, such as the memory device 320 of the example apparatus, and executed by a processor, such as the processor 310 of the example apparatus. As will be appreciated, any such program code instructions may be loaded onto a computer or other programmable apparatus (e.g., processor, memory device, or the like) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowcharts by a processor, or storage of instructions associated with the blocks or operations of the flowcharts in a computer-readable storage medium, supports combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. An apparatus comprising a processor configured to perform or cause the apparatus to perform at least the following:
receiving a compiled file comprising a plurality of objects, the compiled file being a media file, each of the objects having a particular type, the compiled file being received via a remoting gateway configured to post the compiled file to the apparatus;
parsing the compiled file to identify the objects of the compiled file and produce an index of the objects; and
mapping one or more data or files to one or more of the objects based on the index of the objects, each data or file being of a type conforming to the type of the object to which the respective data or file is mapped;
wherein the compiled file is servable to a viewer device, wherein serving the compiled file includes receiving a request for the compiled file, and in response to the request, determining one or more data or files mapped to one or more of the objects of the compiled file, and serving the compiled file and the determined one or more data or files.

2. The apparatus of claim 1, wherein the processor is configured to further perform or cause the apparatus to further perform:
receiving a request for the compiled file; and in response to the request,
determining one or more data or files mapped to one or more of the objects of the compiled file, the respective one or more data or files being determined based on the mapping; and
serving the compiled file and the determined one or more data or files, the compiled file and objects of the compiled file thereby being presentable with the respective one or more data or files.

3. The apparatus of claim 1, wherein mapping one or more data or files comprises:
exposing references to identities of the compiled file and the objects of the compiled file, the references being exposed to a graphical user interface at least partially based on the index of the objects; and
receiving input directing the mapping of one or more data or files to one or more of the objects, the input being received via the graphical user interface and based on the references.

4. The apparatus of claim 3, wherein the graphical user interface is implemented by a remote device configured to access the references and provide the input via a network.

5. The apparatus of claim 1, wherein the one or more data or files mapped to the objects of the compiled file are stored remote from the compiled file, the respective one or more data or files being accessible to the apparatus via a network.

6. The apparatus of claim 1, wherein mapping one or more data or files comprises mapping a plurality of data or files to each of one or more of the objects, wherein for each object mapped to a plurality of data or files, determining one or more data files including determining one of the respective data or files based on one or more logic rules.

7. The apparatus of claim 1, wherein receiving a compiled file, parsing the compiled file, and mapping one or more data or files to one or more of the objects occur for a plurality of different compiled files, and wherein the processor is configured to further perform or cause the apparatus to further perform:
receiving a request for a compiled file; and in response to the request,
determining one of the compiled files to serve;
determining one or more data or files mapped to one or more of the objects of the determined compiled file, the respective one or more data or files being determined based on the mapping; and
serving the determined compiled file and one or more data or files, the determined compiled file and objects of the compiled file thereby being presentable with the respective one or more data or files.

8. The apparatus of claim 1, wherein receiving a request comprises receiving a request from a viewer device comprises receiving a request from a viewer device, and serving the determined compiled file and one or more data or files comprises serving the determined compiled file and one or more data or files to the viewer device,
wherein the processor is configured to further perform or cause the apparatus to further perform receiving feedback from the viewer device before determining one of the compiled files to serve, and
wherein determining one of the compiled files comprises determining one of the compiled files to serve based on the feedback.

9. A method comprising:
receiving a compiled file comprising a plurality of objects, the compiled file being a media file, each of the objects having a particular type;
parsing the compiled file to identify the objects of the compiled file and produce an index of the objects; and
mapping one or more data or files to one or more of the objects based on the index of the objects, each data or file being of a type conforming to the type of the object to which the respective data or file is mapped;
wherein the compiled file is servable to a viewer device, wherein serving the compiled file includes receiving a request for the compiled file, and in response to the request, determining one or more data or files mapped to one or more of the objects of the compiled file, and serving the compiled file and the determined one or more data or files, and
wherein receiving a compiled file, parsing the compiled file and mapping one or more data or files are performed by an apparatus comprising a processor configured parse the compiled file and map one or more data or files, the apparatus being configured to receive the compiled file via a remoting gateway configured to post the compiled file to the apparatus.

10. The method of claim 9 further comprising:
receiving a request for the compiled file; and in response to the request,
determining one or more data or files mapped to one or more of the objects of the compiled file, the respective one or more data or files being determined based on the mapping; and
serving the compiled file and the determined one or more data or files, the compiled file and objects of the compiled file thereby being presentable with the respective one or more data or files.

11. The method of claim 9, wherein mapping one or more data or files comprises:
exposing references to identities of the compiled file and the objects of the compiled file, the references being exposed to a graphical user interface at least partially based on the index of the objects; and
receiving input directing the mapping of one or more data or files to one or more of the objects, the input being received via the graphical user interface and based on the references.

12. The method of claim 11, wherein the graphical user interface is implemented by a remote device configured to access the references and provide the input via a network.

13. The method of claim 9, wherein the one or more data or files mapped to the objects of the compiled file are stored remote from the compiled file, the respective one or more data or files being accessible to the apparatus via a network.

14. The method of claim 9, wherein mapping one or more data or files comprises mapping a plurality of data or files to each of one or more of the objects, wherein for each object mapped to a plurality of data or files, determining one or more data files including determining one of the respective data or files based on one or more logic rules.

15. The method of claim 9, wherein receiving a compiled file, parsing the compiled file, and mapping one or more data or files to one or more of the objects occur for a plurality of different compiled files, and wherein the method further comprises:
receiving a request for a compiled file; and in response to the request,
determining one of the compiled files to serve;
determining one or more data or files mapped to one or more of the objects of the determined compiled file, the respective one or more data or files being determined based on the mapping; and
serving the determined compiled file and one or more data or files, the determined compiled file and objects of the compiled file thereby being presentable with the respective one or more data or files.

16. The method of claim 9, wherein receiving a request comprises receiving a request from a viewer device comprises receiving a request from a viewer device, and serving the determined compiled file and one or more data or files comprises serving the determined compiled file and one or more data or files to the viewer device,
wherein the method further comprises receiving feedback from the viewer device before determining one of the compiled files to serve, and
wherein determining one of the compiled files comprises determining one of the compiled files to serve based on the feedback.

17. A computer-readable storage medium having computer-readable program code portions stored therein that in response to execution by a processor cause an apparatus to perform at least the following:
receiving a compiled file comprising a plurality of objects, the compiled file being a media file, each of the objects having a particular type, the compiled file being received via a remoting gateway configured to post the compiled file to the apparatus;
parsing the compiled file to identify the objects of the compiled file and produce an index of the objects; and
mapping one or more data or files to one or more of the objects based on the index of the objects, each data or file being of a type conforming to the type of the object to which the respective data or file is mapped;
wherein the compiled file is servable to a viewer device, wherein serving the compiled file includes receiving a request for the compiled file, and in response to the request, determining one or more data or files mapped to one or more of the objects of the compiled file, and serving the compiled file and the determined one or more data or files.

18. The computer-readable storage medium of claim 17 having further computer-readable program code portions stored therein that in response to execution by the processor cause the apparatus to perform:
receiving a request for the compiled file; and in response to the request,
determining one or more data or files mapped to one or more of the objects of the compiled file, the respective one or more data or files being determined based on the mapping; and
serving the compiled file and the determined one or more data or files, the compiled file and objects of the compiled file thereby being presentable with the respective one or more data or files.

19. The computer-readable storage medium of claim 17, wherein mapping one or more data or files comprises:
exposing references to identities of the compiled file and the objects of the compiled file, the references being exposed to a graphical user interface at least partially based on the index of the objects; and
receiving input directing the mapping of one or more data or files to one or more of the objects, the input being received via the graphical user interface and based on the references.

20. The computer-readable storage medium of claim 19, wherein the graphical user interface is implemented by a remote device configured to access the references and provide the input via a network.

21. The method of claim 17, wherein the one or more data or files mapped to the objects of the compiled file are stored remote from the compiled file, the respective one or more data or files being accessible to the apparatus via a network.

22. The computer-readable storage medium of claim 17, wherein mapping one or more data or files comprises mapping a plurality of data or files to each of one or more of the objects, wherein for each object mapped to a plurality of data or files, determining one or more data files including determining one of the respective data or files based on one or more logic rules.

23. The computer-readable storage medium of claim 17, wherein receiving a compiled file, parsing the compiled file, and mapping one or more data or files to one or more of the objects occur for a plurality of different compiled files, and wherein the computer-readable storage medium has further computer-readable program code portions stored therein that in response to execution by the processor cause the apparatus to perform:
receiving a request for a compiled file; and in response to the request,
determining one of the compiled files to serve;
determining one or more data or files mapped to one or more of the objects of the determined compiled file, the respective one or more data or files being determined based on the mapping; and
serving the determined compiled file and one or more data or files, the determined compiled file and objects of the compiled file thereby being presentable with the respective one or more data or files.

24. The computer-readable storage medium of claim 17, wherein receiving a request comprises receiving a request from a viewer device comprises receiving a request from a viewer device, and serving the determined compiled file and one or more data or files comprises serving the determined compiled file and one or more data or files to the viewer device,
wherein the computer-readable storage medium has further computer-readable program code portions stored therein that in response to execution by the processor cause the apparatus to perform receiving feedback from the viewer device before determining one of the compiled files to serve, and
wherein determining one of the compiled files comprises determining one of the compiled files to serve based on the feedback.
